(19) United States
(12) Patent Application Publication
(10) Pub. No.: US 2026/0148489 A1
(43) Pub. Date: May 28, 2026

(54) SIMULATION OF A MOSAIC FILTER SENSOR BY TRANSFORMATION OF THE NATIVE COLOR SPACE OF A VIRTUAL ENVIRONMENT INTO A SENSOR PIXEL BRIGHTNESS

(71) Applicant: dSPACE GmbH, Paderborn (DE)

(72) Inventors: Ilja TSCHERKASSOW, Paderborn (DE); Stefan HANTE, Paderborn (DE); Merlin ARIANS, Bremen (DE)

(73) Assignee: dSPACE GmbH, Paderborn (DE)

(21) Appl. No.: 19/180,614

(22) Filed: Apr. 16, 2025

(30) Foreign Application Priority Data
Nov. 22, 2024 (DE) 10 2024 134 483.0

(51) Int. Cl. G06T 15/50; G06T 7/90; G06T 15/20

(52) U.S. Cl. CPC G06T 15/506; G06T 7/90; G06T 15/20; G06T 2207/10024

(57) ABSTRACT

A method for generating synthetic image data for imitating raw camera data from a mosaic filter sensor. The mosaic filter sensor comprises an arrangement of sensor pixels and, in addition, a mosaic filter designed as a periodic mosaic of color filters of different colors that are arranged such that each sensor pixel from the arrangement of sensor pixels is covered by exactly one color filter. The method comprises a positioning and spatial orientation of a virtual camera in a three-dimensional virtual environment on a computer system and a simulation of an imaging by camera optics of colored light on sensor pixels of a mosaic filter sensor incorporated in the virtual camera. Via a reading of the pixel brightness measure associated with the respective color value, the pixel brightness of the respective sensor pixel is derived as a function of the color value of the light imaged on the sensor pixel.

This nonprovisional application claims priority under 35 U.S.C. § 119 (a) to German Patent Application No. 10 2024 134 483.0, which was filed in Germany on Nov. 22, 2024, and which is herein incorporated by reference.

### BACKGROUND OF THE INVENTION

### Field of the Invention

The present invention relates to a method for generating synthetic image data that are suitable for imitating raw camera data generated by a mosaic filter sensor.

### Description of the Background Art

In the development of computer-based control systems, it has been known and customary for many years to operate control systems in virtual working environments in order to test their response to external stimuli. To this end, data that a system under test (SUT), i.e. a control system under test or device under test, takes in by means of sensors is synthetically generated by a simulator computer and fed into the SUT at suitable interfaces. Depending on the requirements on the test conditions, the complexity of the simulation in this case can handle a broad spectrum, from simply feeding in already precalculated data all the way to a complex virtual environment that includes a detailed simulation of the electromechanical working environment of the control system as well as simulated external actors that act on the simulated working environment. The simulation can also be designed as a closed control loop that acquires and takes into account control data generated by the control system on the basis of the synthetic data that are fed in. Virtual test environments offer multiple advantages over field tests in the physical world. They are inherently safe, exactly reproducible, and extreme test scenarios that rarely occur in the real world can be created easily. However, the provision of a sufficiently realistic virtual test environment is complex, and is all the more complex the more sensor data the system under test processes and the more sensitively it reacts to changes in the sensor data.

In the recent past, there have been great advances in the development of highly automated to autonomous robotic systems that can at least briefly navigate independently and safely in changing environments, for example in road traffic, in crowds of people, on unfamiliar surfaces, on agricultural fields, or in combat environments. By necessity, such autonomous systems have at least one imaging sensor from whose delivered sensor data it is possible to derive a detailed image of the near environment that includes the topology of the environment as well as the type, location, and state of motion of objects. In parallel to this development, in order to be able to test robotic systems of this nature in a virtual environment as described above, sensor simulations came onto the market that can generate synthetic image data from a virtual imaging sensor located in the virtual environment in order to stimulate a control system with the image data and compare its responses thereto with a target specification.

Imaging sensors are, for example, cameras, radars or lidars. Cameras have the advantage that, as passive sensors, they are relatively cheap and at the same time deliver a detail-rich and high-resolution image from which much information can be extracted. Different technologies exist among camera image sensors, in turn. Mosaic filter sensors are especially inexpensive, and therefore the most widely used. With this technology, the actual image sensor is not color-sensitive. Instead, a mosaic filter is placed in the optical path of the camera in front of the arrangement of sensor pixels on the image sensor. The mosaic filter is a periodic mosaic of color filters that are arranged such that each sensor pixel is covered by exactly one color filter. The mosaic filter is usually a Bayer filter, whose mosaic is composed of 50% green color filters and 25% each of red and blue color filters, but other types of mosaic filters also exist. A mosaic filter sensor overlaid with a Bayer filter is often also referred to as a Bayer sensor. The different color filters lead to strong differences in the exposure of adjacent sensor pixels, and the color information of the image is reconstructed from these differences in post-processing.

Fundamentally, the synthetic image data output by a sensor simulation must match the interface at which they are fed into the SUT, wherein, as a rule of thumb, the simulation of the image data becomes simpler with an increasing degree of processing of the image data at the interface. It is simple to provide an object list of objects in the vicinity of the virtual sensor, their respective type and state of motion, because the virtual environment typically already maintains this information natively. If, in contrast, the synthetic image data are intended to be fed into the image preprocessing of a camera system, then they must imitate the raw data generated by the image sensor of the camera in question. In the prior art, this requires a simulation of the camera optics and of the physical/technical processes within the image sensor.

A camera simulation of this nature is described in the publication “Full Spectrum Camera Simulation for Reliable Virtual Development and Validation of ADAS and Automated Driving Applications,” Rene Molenaar et al., 2015 IEEE Intelligent Vehicles Symposium (IV), for example. Another example is found in the publication “Digital camera simulation,” by Joyce Farrell, Peter B. Catrysse, and Brian Wandell, Applied Optics, Vol. 51 No. 4 (2012).

First and foremost, the simulation of the image sensor is complicated and frequently unsatisfactory in its results. Important parameters must first be ascertained for simulation thereof. This is already a disadvantage in and of itself because the supplier of the sensor may potentially withhold these figures. But even when a realistic, physical/technical software simulation of the image sensor is successfully implemented on the basis of the parameters, the synthetic raw data generated by this simulation frequently do not have a satisfactory similarity to the raw data that the physical image sensor generates, since the latter is designed for exposure to physical light in the real environment. Dynamic, three-dimensional virtual environments are typically modeled with graphics engines such as Unreal Engine from Epic Games, CryEngine from Crytek, or Unity Engine from Unity Technologies. These engines model colored light on the basis of a color space native to the respective engine in a manner that generates a representation that is plausibly realistic for the human eye, but does not correspond to physical reality. Normally, the native color space of a virtual environment is an RGB color space, which is to say based on an additive mixture of discrete red, green, and blue light components.

### SUMMARY OF THE INVENTION

It is therefore an object of the invention is to simplify and to improve the simulation of a mosaic filter sensor for generating synthetic raw camera data.

In an example, a method is provided for generating synthetic image data that are suitable for imitating raw camera data generated by a mosaic filter sensor, for example a Bayer sensor. This means that the synthetic image data are suitable for being fed into a SUT designed to process the raw data in place of the raw camera data generated by a physical mosaic filter sensor and, on the basis of the response of the SUT to the synthetic raw data, to derive a useful assessment of whether the response of the SUT to raw data from the physical mosaic filter sensor corresponds to a desired response.

The method comprises a positioning and spatial orientation of a virtual camera in a three-dimensional virtual environment on a computer system. The virtual environment is preferably a 3D environment calculated, in particular rendered, dynamically and in real time by a graphics engine. The virtual camera is preferably mounted on a virtual representation of a robotic system, wherein, in particular, a momentary positioning and/or a momentary spatial orientation of the camera is specified by an internal state and/or a state of motion and/or a position of the robotic system in the virtual environment. For example, the virtual camera can be arranged on a virtual autonomous motor vehicle that moves in an environment simulated by the virtual environment, for example a simulated road traffic environment.

The method comprises a simulation of an imaging by camera optics of colored light on sensor pixels of a mosaic filter sensor incorporated in the virtual camera. A brightness and a color value from a native color space, for example an sRGB color space, of the virtual environment are defined in each case here for the light imaged on a sensor pixel. For each pixel, both the color value and the brightness of the light depend on the lighting conditions of the spatial region of the virtual environment that the simulated optics of the virtual camera are imaging at the time on the simulated mosaic filter sensor, and in this way are dependent on the position and the spatial orientation of the virtual camera.

The method further comprises a generation of the synthetic image data by means of a simulation of the mosaic filter sensor incorporated in the virtual camera. The simulation of the mosaic filter sensor comprises a derivation of pixel brightnesses of the sensor pixels as a function of the brightness and the color value of the light imaged on the respective sensor pixel. A pixel brightness is preferably to be understood as a measurement quantity that is output by a sensor pixel as a function of a quantity of light of the light imaged on the sensor pixel during an exposure time and is interpreted and represented as the brightness of the pixel by an image processing downstream of the sensor pixel. The pixel brightness can especially preferably represent a simulated electric voltage generated by the sensor pixel and/or a simulated electric current generated by the sensor pixel and/or a simulated electric charge generated by the sensor pixel, and the synthetic image data are generated from the totality of the simulated electric voltages and/or electric currents and/or electric charges.

For simulation of the mosaic filter sensor, provision is made according to the invention to create, for each filter color occurring in the mosaic filter, a mapping table (“lookup table”) associated with the respective filter color, so that at least one mapping table is associated with each filter color and exactly one filter color is associated with each mapping table. For example, a Bayer filter, which is to say the mosaic filter of a Bayer sensor, comprises the filter colors blue, green, and red. For the simulation of a Bayer sensor, the invention accordingly provides for creation of at least three mapping tables, of which (without loss of generality) the first is uniquely associated with the filter color blue, the second is uniquely associated with the filter color green, and the third is uniquely associated with the filter color red. Some Bayer sensors also include two different green color filters whose transmission spectra differ slightly. These different green hues can be interpreted as different filter colors. In this case, the method according to the invention can also comprise creation of a fourth mapping table in order to maintain a separate mapping table for each of the two green hues occurring in the mosaic filter.

The mapping tables are designed such that, in each mapping table, a pixel brightness measure can be associated in each case with a multiplicity of color values from a raster scan of the native color space of the virtual environment. A pixel brightness measure is to be understood as a quantity from which it is possible to derive a pixel brightness of a sensor pixel that is covered by a color filter of the associated filter color and is exposed to light of the respective color value. A derivation of a pixel brightness can be understood in this context as a direct reading of the pixel brightness from the respective mapping table, but also as a calculation of the pixel brightness while taking into account the pixel brightness measure. For the calculation, it is also possible to take into account, in particular, a quantity of light of the light imaged on the respective sensor pixel, especially advantageously a light intensity and an exposure time.

Naturally, it is not necessary for every generation of synthetic image data by means of a simulation of a mosaic filter sensor according to the invention to repeat the step of creating the mapping tables. Advantageously, suitable mapping tables for a given model line of mosaic filter sensor are created once and subsequently stored, if applicable also stored multiple times on spatially distributed storage media, and distributed, in order to retrieve them and reuse them for subsequent simulations of the mosaic filter sensor in question.

To generate the synthetic image data, provision is made for the sensor pixels of the simulated mosaic filter sensor to check the filter color of the color filter covering the respective sensor pixel and, after the check, to consult the mapping table associated with the respective filter color in each case. For a multiplicity of sensor pixels, in particular for all sensor pixels, of the simulated mosaic filter sensor, the color value of the light imaged on the respective sensor pixel is then determined, and the pixel brightness measure associated with the respective color value is read from the respective mapping table consulted for the respective sensor pixel, in order to derive a pixel brightness of the respective pixel from the pixel brightness measure and to generate the synthetic image data from the totality of the pixel brightnesses derived for the sensor pixels.

Mapping tables for the transformation of colors are known in the prior art from a color correction method called “color grading,” which is used in films and video games primarily from an aesthetic standpoint. In this process, color values from a color space, which can be, e.g., a color space of a computer-generated virtual environment, are transformed into other color values of the same color space by means of mapping tables in order to change the color mood of a depicted scene.

The mapping tables of the method according to the invention, in contrast, transfer the color space of a virtual environment to the “color space” of a mosaic filter sensor. This transformation permits a purely empirical, but realistic, simulation of the sensor while bypassing the physical/technical processes in the sensor, and in this way considerably simplifies the generation of realistic, synthetic image data. Because of the elimination of the physical simulation of the camera sensor, a camera simulation by means of the mapping tables according to the invention can, moreover, be carried out very rapidly and with relatively low demands on computing resources. As a result, it is especially suitable for camera simulations in real time (i.e., in hard real time at the same operating speed that would also be offered by a physical camera in a real environment), such as are necessary for stimulation of physical SUTs (“hardware in the loop”).

The raster underlying the raster scan of the native color space is advantageously designed as a regular grid of color values in the native color space. The spacing of the grid points can correspond to a resolution limit of the native color space. When the spacing of the grid points is larger than the resolution limit of the native color space, provision can be made in the reading of the pixel brightness measure associated with a color value to read the pixel brightness measure from a grid point adjacent to the color value or to interpolate in order to read the pixel brightness measure between the pixel brightness measures that are associated with at least two adjacent grid points.

The mapping tables can be created on the basis of measurements. The performance of the measurements comprises a generation of one physical representation each of a multiplicity of color values of the native color space in the form of an electromagnetic wave that can be captured with a camera, and additionally a capturing of each physical representation from the multiplicity of physical representations using a physical camera in which a mosaic filter sensor is incorporated. In other words, light of the respective color value (which is to say of an electromagnetic spectrum corresponding to the color value) is thus generated for different color values and used to expose at least one sensor pixel of the mosaic filter sensor. In this process, the raw data generated by each color channel of the mosaic filter sensor are measured for each color value. (Each color channel corresponds to a filter color occurring on the mosaic filter). The raw data here correspond in particular to an electrical response of the sensor pixels, which is to say electric voltages, electric currents, or electric charges generated as a result of the exposure of the sensor pixels.

The mapping tables can then be created on the basis of the measured values determined by the measurement. To this end, it is necessary to translate the spectral colors of the measured electromagnetic waves into the corresponding colors of the native color space of the virtual environment. Guidance for this appears further below.

The pixel brightness measures stored in the mapping tables in this example represent the actual, measured sensor pixel responses of the mosaic filter sensor incorporated in the physical camera. As a result, the mapping tables are designed to emulate the electrical sensor pixel responses of precisely this mosaic filter sensor during the course of a method according to the invention. As a result, they are especially suitable for testing an SUT that is intended to utilize image data from a camera that belongs to the same model line as the physical camera in which the mosaic filter sensor used for the measurements was or is incorporated.

Different possibilities exist for generating the electromagnetic waves, wherein the capturing of the physical representations of the different color values can, in principle, be accomplished serially or in parallel. For example, the generation of the electromagnetic wave of each color value to be measured can take place serially with a special light source that is designed to emit light of a desired, variable electromagnetic spectrum in the visible or near-visible range with adequately high quality.

Preferably, however, the generation of the electromagnetic waves is accomplished through illumination of at least one color chart, such as can be purchased for calibration of a camera, for example. A feature of the color charts that is essential to the invention is that they represent a multiplicity of color values on one area, either on a single color chart or distributed over a multiplicity of color charts, wherein a characteristic reflection spectrum for the color value on the color chart is well-defined and known for each color value. The color chart is irradiated with light having a well-defined electromagnetic spectrum, and the color chart thus irradiated is captured by means of the physical camera in order to measure the electrical responses of the sensor pixels to the color values represented on the color chart.

Advantageously, the color values represented on the at least one color chart already form a raster scan of the native color space, so that the color values represented on the at least one color chart, transformed into the native color space of the virtual environment, form a raster covering the native color space in its entire scope. Especially advantageously, the number of color values represented on the color chart is high enough that the grid points of the raster are sufficiently dense that the mapping tables created on the basis of the color chart are immediately usable for carrying out the method according to the invention without first increasing the number of pixel brightness measures stored in the mapping tables, for example by interpolation of the pixel brightness measures.

Standard, commercially available color charts do not meet the latter condition, however. For this reason, the method can include a supplementation of the measured values or of the pixel brightness measures that were obtained on the basis of the colors reproduced on the color chart by an estimation method, in particular by interpolation or extrapolation of the measured values or of the pixel brightness measures. This is true regardless of whether or not the color values reproduced on the color chart already form a raster scan of the native color space of the virtual environment. Most color charts reproduce a rather small and arbitrarily distributed number of color values, at least from the perspective of the invention. In such a case, an after-the-fact supplementation of the measured values is advantageous for achieving a grid-like and sufficiently dense raster scan.

It was already mentioned above that the electromagnetic spectrum of the light used for illumination of the color chart must be well-defined and known. Experts refer to specific radiation distribution curves (electromagnetic spectra) of illuminations as illuminants, and some specific illuminants are declared so-called standard illuminants. Examples include standard illuminant A (incandescent lamp), D65 (standard daylight), F1 to F6 (fluorescent lamp, various types), and LED-RGB1 (white LED light).

It is obvious that the raw data generated by a digital camera depend upon the illuminant of the camera environment, and it is sensible to take this dependence into account for a realistic simulation of the camera. Accordingly, provision is made in an example of the invention to capture an illuminant defined by the radiation distribution curves of the illumination of the color chart and to associate the mapping tables created with this illumination with the illuminant. Correspondingly, the generation of synthetic image data for imitating raw camera data from the physical mosaic filter sensor can then occur under the assumption that the physical camera, in which the physical mosaic filter sensor is incorporated and whose image data generation is to be simulated, is located in an environment that is illuminated in accordance with the illuminant. Preferably, the illuminant is designed to emulate a typical illuminant encountered in the physical world, and, in particular, can also be a standard illuminant.

Many virtual environments natively maintain a multiplicity of different (standard) illuminants and are designed to dynamically match the rendering of the virtual environment to an illuminant that has just been selected. When a virtual environment that is designed in this manner is used, it is especially advantageous to prepare and maintain multiple sets of mapping tables that are matched to different illuminants maintained by the virtual environment. The mapping tables can, for example, be prepared with a color chart as described above by executing the described sequence of method steps for creating the mapping tables multiple times, wherein a different illuminant for the illumination of the color chart is selected at each execution, and the created mapping tables are associated in each execution with the illuminant that is selected for the illumination in the then-current execution. The mapping tables that are associated with the illuminant represented by the virtual environment can then be selected in a flexible manner to generate the synthetic image data. During the generation of the synthetic image data, the mapping tables can also be exchanged dynamically, in particular in a situation-dependent or location-dependent manner, and in each case the mapping tables that the virtual environment is currently using for the rendering of the virtual environment can be used in a flexible manner. If, for example, the virtual camera is located on a virtual, automated vehicle that is moving in the virtual environment, then the mapping tables can be flexibly exchanged in a situation-dependent manner, for example depending on what time of day and/or what weather conditions are being represented in the virtual environment or whether the virtual vehicle is currently located in a shaded area, in direct sunlight, or in an underpass with artificial lighting.

The creation of the mapping tables can be accomplished by a simulation instead of a measurement. In the course of this simulation, the pixel brightness measure is calculated for each color value, wherein at least one transmission spectrum of the respective color filter with which the mapping table to be calculated is associated, and a quantum efficiency of a sensor pixel, are taken into account in each case for the calculation of the pixel brightness measures. Advantageously, an illuminant is additionally taken into account for the calculation of the pixel brightness measures. The illuminant, for example a standard illuminant, is characterized and defined by radiation distribution curves of light that can illuminate an environment of the physical camera to be simulated. As described above in connection with a measurement-based creation of the mapping tables, the mapping table calculated in this way can also be associated with the illuminant in order to carry out, as described, the generation of synthetic image data for imitating raw camera data from the physical mosaic filter sensor under the assumption that the physical camera is located in an environment that is illuminated in accordance with the illuminant.

The creation of the mapping tables can take place on the basis of a hybrid procedure that comprises both a measurement as described above and a simulation, which is to say calculation, of the pixel brightness measures as described above, wherein the results of both the measurement and the simulation are taken into account in the creation of the mapping tables.

The invention also relates to a computer program product that comprises mapping tables according to the preceding description as well as means for generating synthetic image data according to the preceding description.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates a mode of operation of a mosaic filter sensor;

FIG. 2 shows a measuring setup and a sequence for creating the mapping tables; and

FIG. 3 is a flowchart for creating the synthetic image data after the creation of the mapping tables.

### DETAILED DESCRIPTION

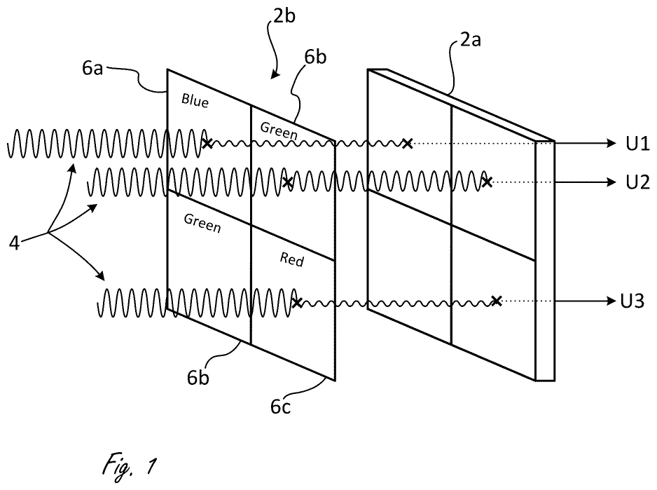

The illustration in FIG. 1 outlines the operating principle of a mosaic filter sensor 2. The mosaic filter sensor 2 comprises a matrix arrangement of sensor pixels 2a and a mosaic filter 2b, designed as a periodic, matrix mosaic of color filters 6. The mosaic filter 2b is arranged on the optical axis of the camera in which the mosaic filter 2b is incorporated, in front of the arrangement of sensor pixels 2a, and covers the arrangement of sensor pixels 2a. The color filters 6 are arranged such that each sensor pixel of the arrangement of sensor pixels 2a is covered by exactly one color filter 6.

For improved representation, only a small section formed of two by two sensor pixels from the arrangement of sensor pixels 2a is shown, and correspondingly only a submosaic formed of two by two color filters 6 from the mosaic filter 2b. A real mosaic filter sensor 2 typically comprises several million sensor pixels and a corresponding number of color filters 6 on the mosaic filter 2b. The mosaic filter 2b is represented by way of example as a Bayer filter, which is to say the submosaic is composed of one blue color filter 6a, two green color filters 6b, and one red color filter 6c. This submosaic is arranged in multiple copies next to one another on the mosaic filter 2b along both axes so that a periodic, which is to say identically repeating, mosaic of color filters 6 of the colors green, red, and blue results as a whole.

Camera optics 8 project ambient light onto the mosaic filter 2b. Shown by way of example is how an electromagnetic wave 4 in the green spectral region strikes the depicted submosaic of the mosaic filter sensor 2b. The color filters 6 of the mosaic filter 2b leave the wavelength, or the spectral curve, of the wave 4 unchanged, but reduce the amplitude of the wave 4 to different degrees depending on the respective transmission spectra of the different color filters 6. While the wave 4 passes through the green color filter 6b with little loss, the blue color filter 6a and the red color filter 6c absorb a majority of the energy of the green light passing through them, and the amplitude of the wave 4 is sharply reduced after passage through the blue color filter 6a and the red color filter 6c.

The light passing through the individual color filters 6 is projected by microlenses onto the sensor pixels. Each individual sensor pixel is a photodetector that converts photons into electrons and in this way generates an electric current whose current amplitude is proportional to the photon density over time of the light projected onto the respective sensor pixel. Each sensor pixel includes an electrical capacitor, which is charged by the electric current and builds up an electric voltage proportional to the electric current within a defined time, for instance an exposure time of the camera. The electric voltages are captured by a sensor system and forwarded to image preprocessing 14 of the camera, which reconstructs the color information of the image from the differences in the voltages read from adjacent sensor pixels.

In the illustration, by way of example a voltage U1 is being read from the blue color filter 6a, a voltage U2 from the adjacent green color filter 6b, and a voltage U3 from the adjacent red color filter 6c. Since the wave 4 is located in the green spectral region and only the green color filter is optimized for the transmissivity of green light, the voltages U1 and U3 are considerably smaller than the voltage U2. Under the plausible assumption that the entire depicted submosaic is illuminated approximately uniformly, the image preprocessing 14 can conclude from the measured voltage differences that the wave 4 exposing the submosaic is green, and can store the corresponding color information in the image pixels.

The totality of the electric voltages read during an individual exposure process, which is to say the voltages U1, U2, U3, and all additional voltages read by the individual sensor pixels, are the raw camera data from which the camera, in further processing steps, creates an image that can be displayed on a display device, for example in JPG format or in raw format, in that it interprets the voltages as pixel brightnesses. The raw camera data in the depicted example are thus a matrix composed of electric voltages, which resembles the matrix composed of sensor pixels in terms of dimensions. The raw data do not necessarily have to represent electric voltages, however. Depending on the model of the camera, the raw data can also represent electric currents or electric charges, for example. In addition, the raw data do not necessarily have to represent the electric voltages or the electric currents or the electric charges directly, but can instead also represent a quantity derived therefrom, in particular a quantity derived by scaling.

For each sensor pixel, there is thus a linear dependency between the intensity or the quantity of light (photon count) of the light projected on a color filter during an exposure process and the electric voltage U1, U2, U3, . . . that is read from the sensor pixel covering the respective color filter 6 during the course of the same exposure process. The relationship between the quantity of light and the voltage generated therefrom is determined essentially by two quantities: the wavelength-dependent transmittance of the color filter 6, the so-called transmission spectrum, and the likewise wavelength-dependent quantum efficiency of the sensor pixel. The transmittance is the light component that passes through the color filter, which is to say the relationship of the light intensities before and after the color filter, and the quantum efficiency is a measure of the efficiency with which a sensor pixel converts light into electric current. The pixel brightness measures stored in the mapping tables represent the linear dependency of the voltage U1, U2, U3, . . . on the light intensity or on the quantity of light of the light imaged on the respective sensor pixel for one well-defined color of the wave 4 in each case.

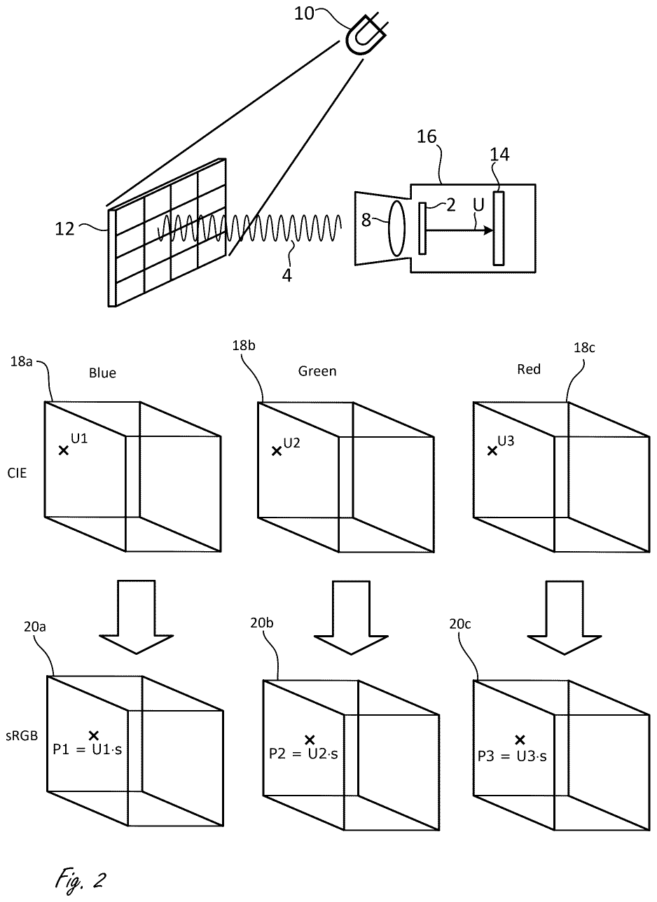

At the top, the illustration in FIG. 2 shows a setup for creating the mapping tables on the basis of a measurement. The measuring setup includes a color chart 12 as well as a light source 10 that is designed and arranged such that it illuminates the color chart 12 uniformly and with a well-defined illuminant. The color chart 12 is intended and designed for calibration of a camera. It includes, by way of example, sixteen differently colored color fields of which each one has a well-defined color value with a well-defined reflection spectrum. This means that an electromagnetic wave 4 with a well-defined electromagnetic spectrum, which constitutes a physical representation of the color value of the respective color field, radiates from each individual color field. The camera 16 is arranged for an imaging of the color chart 12 so that the lens 8 images the magnetic wave 4 radiating from each color field onto a subsection of the mosaic filter sensor 2. As described in the description of FIG. 1, the mosaic filter sensor 2 generates the raw data U as a matrix of pixel brightnesses (here: electric voltages).

As a preliminary step for creating the mapping tables 20, six three-dimensional arrays 18, 20 are allocated on a computer system. Three of the arrays represent a CIE color space. The CIE color spaces are a class of tristimulus color spaces that are optimized to reflect the color perception of the human eye based on the excitation of three types of biological photoreceptors (cones). Three additional arrays represent a native color space of the virtual environment, an sRGB color space by way of example. The sRGB color space belongs to the RGB color spaces, a class of tristimulus color spaces that are optimized to stimulate the cones in the human eye in such a manner that a desired color perception is produced for a viewer, by driving red, green, and blue light-emitting elements in the image pixels of a display device. Commonly used graphics engines for generating a virtual environment typically render the virtual environment on the basis of an RGB color space.

Generally speaking, a native color space of the virtual environment is to be understood to mean, in particular, a color space on the basis of which the virtual environment is rendered or that is at least sufficiently similar to the color space on the basis of which the virtual environment is rendered. Advantageously, both color spaces, the color space selected as the “native color space” of the mapping tables 20 and the color space used for rendering the virtual environment, belong to at least the same class of color spaces. By way of example, it is possible in an example of the invention to create the mapping tables 20 for an sRGB color space (which is to say, to consider the sRGB color space as the “native color space”), even though the virtual environment is rendered on the basis of a specialized RGB color space, but which is similar enough to the sRGB color space that the synthetic image data nevertheless imitate the raw camera data sufficiently well.

Depicted in the illustration is the way the electromagnetic wave 4 that is already shown in FIG. 1 is emitted from a color field of the color chart 12, and consequently is a physical representation of the color value shown in this very same color field. The raw data U are read for the purpose of creating the mapping tables 20. As already explained above, the raw data U are a matrix of electric voltages in which each matrix entry represents a single, well-defined sensor pixel of the mosaic filter sensor 2. Four sensor pixels are identified that are covered by a submosaic of the mosaic filter 2b and are located in a subsection of the mosaic filter sensor 2 that is exposed by the electromagnetic wave 4. The electric voltages U1, U2, and U3 are read directly from the matrix entries of the raw data U that represent the identified sensor pixels.

A first array 18a, a second array 18b, and a third array 18c each represent the CIE color space. The first array 18a, the second array 18b, and the third array 18c do not represent different CIE color spaces, but instead are three independent instances of one and the same CIE color space. A unique CIE coordinate is associated with the color value, which is to say the electromagnetic spectrum, of the electromagnetic wave 4 in the CIE color space; this coordinate is indicated by a cross in the illustration. In the first array 18a, the electric voltage U1 is stored at this coordinate. The first array 18a is associated with the blue color filter 6a of the mosaic filter 2b. In the second array 18b, the electric voltage U2 is stored at this coordinate. The second array 18b is associated with the green color filter 6b of the mosaic filter 2b. In the third array, the electric voltage U3 is stored at this coordinate. The third array 18c is associated with the red color filter 6c of the mosaic filter 2b.

The three as yet empty arrays, which represent the sRGB color space (or more generally: the native color space), are the mapping tables 20. A first mapping table 20a is associated with the blue color filter 6a of the mosaic filter sensor 2b. Associated with the CIE coordinate from the CIE color space is a unique sRGB coordinate in the sRGB color space, which again is indicated by a cross. The associated sRGB coordinate represents the sRGB color value which creates the same color impression in the human eye of a standardized viewer as the previously determined color value of the CIE coordinate or as the electromagnetic wave 4, and can be determined from the CIE coordinate through known and generally accessible transformation formulas. In the first mapping table 20a, a first pixel brightness measure P1 is stored at the sRGB coordinate. The first pixel brightness measure is the result of a multiplication of the electric voltage U1 by a scaling factor s in order to normalize the electric voltage U1 to a standard brightness of the wave 4 and a standard exposure time.

A second mapping table 20b is associated with the green color filter 6b of the mosaic filter sensor 2b. In the second mapping table 20b, a second pixel brightness measure P2 is stored at the sRGB coordinate. The second pixel brightness measure P2 is the result of a multiplication of the electric voltage U2 by the scaling factor s.

A third mapping table 20c is associated with the red color filter 6c of the mosaic filter sensor 2b. In the third mapping table 20c, a third pixel brightness measure P3 is stored at the sRGB coordinate. The third pixel brightness measure P3 is the result of a multiplication of the electric voltage U3 by the scaling factor s.

The process described is repeated analogously for each color value represented on the color chart 12. After that, in the example of the depicted color chart 12, sixteen pixel brightness measures, corresponding to the sixteen imaged color values, would be stored at sixteen different sRGB coordinates in each mapping table 20.

When required, if the pixel brightness measures stored in the mapping tables 20 do not yet represent a raster scan of the sRGB color space or if the spacings of the grid points of the raster are too large, the pixel brightness measures stored in the mapping tables 20 can be supplemented by a mathematical estimation method, for example by an interpolation and/or extrapolation method. Since such methods, in particular extrapolation methods, can at best produce approximate pixel brightness measures, the color chart 12 is advantageously designed such that the pixel brightness measures stored in the mapping tables 20 by measurement already form a scan, in particular raster scan, that covers the native color space approximately completely. Extremely advantageously, the color chart is designed such that the pixel brightness measures stored in the mapping tables 20 by measurement already cover the native color space densely enough, in particular by forming a raster scan, that no supplementation of the pixel brightness measures by an interpolation method is necessary.

The completed mapping tables 20 are functions [symbol] ³→ [symbol] that specify a pixel brightness measure for each sRGB color value from which it is possible to determine, by a simple adjustment with some dynamic variables, in particular brightness or intensity of the wave 4 and exposure time, an electrical response of a sensor pixel that corresponds to the electrical response of the relevant sensor pixel in the physical camera 16 when the pixel is exposed to light having an electromagnetic spectrum that creates the same color impression for a human viewer as the respective sRGB color value.

The three mapping tables 20 relate to the illuminant emitted by the light source 10. Other illuminants generate other spectra of the waves emitted by the color fields of the color chart 12. The process described above in connection with FIG. 2 can be repeated multiple times with different light sources 10 that emit different illuminants in order to create and maintain mapping tables 20 for different illuminants.

Since the processes responsible for converting light into electric voltages (transmission by the color filters 6 and photodetection by the sensor pixels) are known and quantifiable, the pixel brightness measures in the mapping tables 20 can alternatively also be calculated by a computer simulation of the said processes.

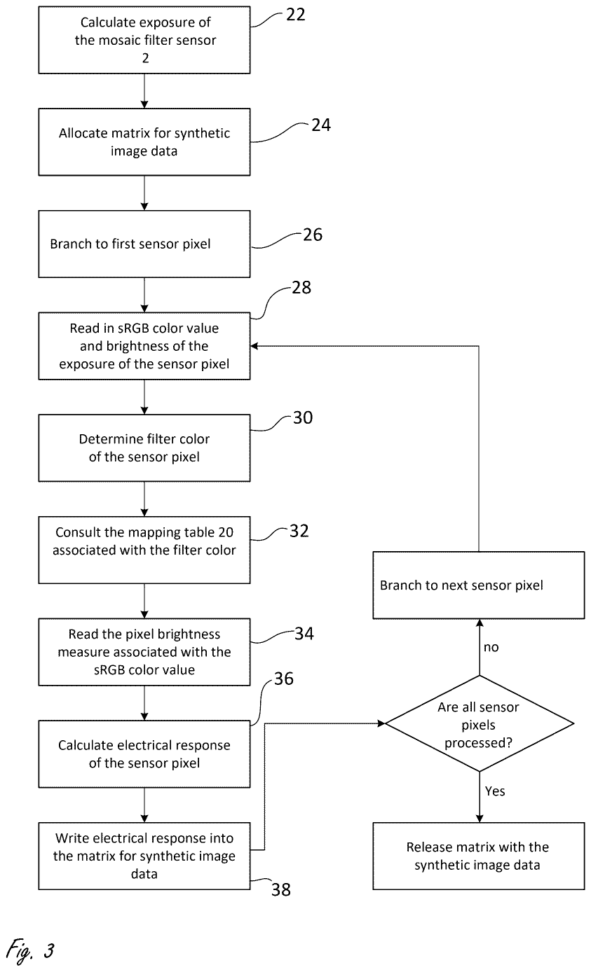

The flowchart in FIG. 3 outlines the way the mapping tables 20 are used for simulating the mosaic filter sensor 2.

In a first simulation step 22, an exposure of the mosaic filter sensor 2 is calculated by means of a simulation of the camera optics 8 and on the basis of a current state of the virtual environment comprising a current positioning and spatial orientation of the virtual camera as well as a number of additional static and dynamic graphic objects of the virtual environment. After conclusion of the calculation of the exposure, an exposure of the respective sensor pixel, which comprises an sRGB color value and a brightness or a quantity of light of a wave 4 exposing the respective sensor pixel, is calculated for each sensor pixel of the virtual mosaic filter sensor 2. For the purpose of storing the synthetic image data, in a second simulation step 24 a matrix is allocated that comprises an entry for saving the electrical response of the relevant sensor pixel for each sensor pixel of the virtual mosaic filter sensor.

The electrical responses of the individual sensor pixels of the virtual mosaic filter sensor 2 are subsequently calculated serially. In a third simulation step 26, a branch takes place to the first sensor pixel, which is to say the first sensor pixel is selected for calculation of the electrical response. In a fourth simulation step 28, the sRGB color value and the brightness of the light exposing the first sensor pixel are read in. Both values, brightness and sRGB color value, were already calculated during the calculation of the overall calculation in the first simulation step 22 and are ready for reading in the fourth simulation step.

In a fifth simulation step 30, the filter color of the sensor pixel is determined. In the virtual camera, a filter color is associated with each sensor pixel of the virtual mosaic filter sensor 2. The filter color associated with a sensor pixel corresponds to the filter color of a color filter in the mosaic of the physical mosaic filter 2b that covers a sensor pixel of a physical mosaic filter sensor 2.

In a sixth simulation step 32, the mapping table 20 associated with the filter color determined in the fifth simulation step 30 is consulted, which is to say called up. In a seventh simulation step 34, the pixel brightness measure is read from the mapping table 20 consulted in the sixth simulation step 32, which brightness measure is associated with the sRGB color value that was read-in in the fourth simulation step 28.

In an eighth simulation step 36, the electrical response of the sensor pixel is calculated, taking into account the pixel brightness measure read in the seventh simulation step 34, the exposure time, and the brightness that was read-in in the fourth simulation step 28. In the specific example, the electrical response would be an electric voltage. Under the assumption that the filter color associated with the sensor pixel is blue and the pixel brightness measure read is P1 (see the illustration in FIG. 2), the electrical response can result from the following formula, for example:

$$U 1 = \frac{I}{{I}_{U}} \cdot \frac{E}{{E}_{U}} {P}_{1}$$

where I is brightness, I_{U} is unit brightness, E is exposure time, and E_{U} is unit exposure time. In a ninth simulation step 38, the calculated electrical response is written into the matrix allocated in the second simulation step 24 in the matrix entry that is provided for storage of the electrical response of the sensor pixel.

The electrical responses stored in the matrix are the synthetic image data. After conclusion of the ninth simulation step 38, a check takes place as to whether all sensor pixels have been processed, which is to say whether an electrical response has been calculated and stored in the matrix for every sensor pixel. If this is the case, the matrix with the synthetic image data is released for further processing. In the normal case, this release is to be understood to mean that the synthetic image data stored in the matrix are logically or physically transferred to a downstream instance that reads in and further processes the synthetic image data. The downstream instance can be, in particular, an SUT designed for processing the synthetic image data.

If the check is negative, which is to say all sensor pixels have not yet been processed, a branch takes place to the next sensor pixel and subsequently a branch back to the fourth method step 28 takes place in order to calculate, and store in the matrix, an electrical response for the now-selected sensor pixel in the same manner.

Especially when the SUT expects a continuous stream of image data, the simulation process outlined in FIG. 3 can be executed repeatedly, for example synchronously with a simulated sequence of exposure processes in the virtual camera, wherein each execution of the represented simulation steps generates a burst of synthetic image data, wherein the stream of image data is designed as a continuous time sequence of bursts.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for generating synthetic image data for imitating raw camera data from a mosaic filter sensor, the mosaic filter sensor comprising an arrangement of sensor pixels and a mosaic filter designed as a periodic mosaic of color filters of different colors that are arranged such that each sensor pixel from the arrangement of sensor pixels is covered by exactly one color filter, the method comprising:
positioning and spatial orientation of a virtual camera in a three-dimensional virtual environment on a computer system;
simulating an imaging by camera optics of colored light on sensor pixels of a mosaic filter sensor incorporated in the virtual camera, a brightness and a color value from a native color space of the virtual environment being defined for the light imaged on each sensor pixel as a function of the position and the spatial orientation of the virtual camera;
generating the synthetic image data via a simulation of the mosaic filter sensor incorporated in the virtual camera by derivation of pixel brightnesses of the sensor pixels as a function of the brightness and the color value of the light imaged on the respective sensor pixel;
creating a mapping table associated with the respective filter color for each filter color occurring in the mosaic filter so that at least one mapping table is associated with each filter color and exactly one filter color is associated with each mapping table;
providing the mapping tables such that, in each mapping table, a pixel brightness measure is associated in each case with a plurality of color values from a raster scan of the native color space of the virtual environment, from which it is possible to derive a pixel brightness of a sensor pixel that is covered by a color filter of the associated filter color and is exposed to light of the respective color value;
checking, for the sensor pixels of the simulated mosaic filter sensor, the filter color of the color filter covering the respective sensor pixel;
consulting the mapping table associated with the respective filter color; and
deriving the pixel brightness of the respective sensor pixel as a function of the color value of the light imaged on the respective sensor pixel by reading the pixel brightness measure associated with the respective color value from the mapping table consulted in each case.

2. The method according to claim 1, wherein the raster underlying the raster scan is a regular grid of color values in the native color space.

3. The method according to claim 1, wherein a quantity of light or a light intensity and an exposure time of the light imaged on the respective sensor pixel is taken into account in the derivation of the pixel brightness.

4. The method according to claim 1, wherein the creation of the mapping tables comprises:
generating one physical representation each of a plurality of color values of the native color space in the form of an electromagnetic wave that is adapted to be captured with a camera;
capturing each physical representation from the plurality of physical representations using a physical camera, in which a mosaic filter sensor is incorporated;
measuring raw data generated by each color channel of the mosaic filter sensor as a result of the capturing of the respective physical representation of each color value, each color channel corresponding to a filter color occurring on the mosaic filter; and
creating the mapping tables on the basis of the measured values determined by the measurement, so that the pixel brightness measures stored in the mapping tables represent the sensor pixel responses of the mosaic filter sensor incorporated in the physical camera.

5. The method according to claim 4, wherein at least one color chart or a chart designed for calibration of a camera is illuminated to generate the electromagnetic wave.

6. The method according to claim 5, wherein the color values represented on the at least one color chart form a raster scan of the native color space.

7. The method according to claim 5, wherein the creation of the mapping tables comprises a supplementation by an estimation method or by interpolation or extrapolation of the measured values obtained on the basis of the color values reproduced on the color chart or pixel brightness measures.

8. The method according to claim 5, further comprising:
capturing an illuminant defined by the radiation distribution curves of the illumination of the color chart;
associating the mapping tables with the illuminant; and
generating synthetic image data for imitating raw camera data from the physical mosaic filter sensor under an assumption that the physical camera is located in an environment that is illuminated in accordance with the illuminant,
wherein the illuminant is a standard illuminant and/or is designed to emulate a physical environmental illuminant.

9. The method according to claim 1, wherein, for creating the respective mapping table, the pixel brightness measure is calculated for each color value while taking into account a transmission spectrum of the respective color filter and a quantum efficiency of the sensor pixel.

10. The method according to claim 9, wherein the pixel brightnesses are calculated while taking into account an illuminant defined by radiation distribution curves of the light illuminating an environment of the physical camera, the method further comprising:
associating the mapping tables with the illuminant; and
generating synthetic image data for imitating raw camera data from the physical mosaic filter sensor.

11. The method according to claim 1, wherein the pixel brightnesses represent simulated electric voltages and/or simulated electric currents and/or simulated electric charges generated by the simulated sensor pixels, and wherein the synthetic image data are generated from the totality of the simulated electric voltages and/or electric currents and/or electric charges.

12. A computer program product for generating synthetic image data for imitating raw camera data from a mosaic filter sensor, the mosaic filter sensor comprising:
an arrangement of sensor pixels; and
a mosaic filter designed as a periodic mosaic of color filters of different colors that are arranged such that each sensor pixel from the arrangement of sensor pixels is covered by exactly one color filter,
the computer program product configured to:
position and orientate a virtual camera in a three-dimensional virtual environment on a computer system;
simulate an imaging by camera optics incorporated in the virtual camera of colored light on sensor pixels of a mosaic filter sensor incorporated in the virtual camera, a brightness and a color value from a native color space of the virtual environment being defined for the light imaged on each sensor pixel as a function of the position and the spatial orientation of the virtual camera; and
generate the synthetic image data via a simulation of the mosaic filter sensor incorporated in the virtual camera by derivation of pixel brightnesses of the sensor pixels as a function of the brightness and the color value of the light imaged on the respective sensor pixel,
wherein the computer program product maintains a mapping table for each filter color occurring in the mosaic filter so that at least one mapping table is associated with each filter color and exactly one filter color is associated with each mapping table,
wherein the mapping table is designed such that a pixel brightness measure is associated with a plurality of color values from a raster scan of the native color space of the virtual environment, from which it is possible to derive a pixel brightness of a sensor pixel that is covered by a color filter of the associated filter color and is exposed to light of the respective color value, and
wherein the computer program product is configured to conduct a check of the filter color of the color filter covering the respective sensor pixel, in each case, for the purpose of generating the synthetic image data for the sensor pixels of the simulated mosaic filter sensor, to consult the mapping table associated with the respective filter color, and to derive, by reading of the pixel brightness measure associated with the respective color value, the pixel brightness of the respective sensor pixel as a function of the color value of the light imaged on the sensor pixel.

13. The computer program product according to claim 12, wherein a quantity of light or a light intensity and an exposure time of the light imaged on the respective sensor pixel in the derivation of the pixel brightness is taken into account.

14. The computer program product according to claim 12, wherein the mapping tables are each associated with an illuminant defined by radiation distribution curves, a standard illuminant, and/or an emulation of a physical illuminant, and are designed to generate synthetic image data for imitating raw camera data from the physical mosaic filter sensor under the assumption that the physical camera is located in an environment that is illuminated in accordance with the illuminant.

15. The computer program product according to claim 12, wherein the mapping tables are designed to take into account transmission spectra of the relevant associated color filter and a quantum efficiency of a sensor pixel, using the pixel brightness measures.

16. The computer-implemented method according to claim 1, wherein the mosaic filter sensor is a Bayer sensor.

17. The method according to claim 8, wherein the illuminant is a standard illuminant and/or is designed to emulate a physical environmental illuminant.

18. The method according to claim 9, wherein the physical camera is located in an environment that is illuminated in accordance with the illuminant.
